(19) United States
(12) Patent Application Publication
(10) Pub. No.: US 2016/0263789 A1
(43) Pub. Date: Sep. 15, 2016

(54) METHOD FOR FORMING AN EXTRUSION-FOAMED PLASTIC LAYER AND AFTERTREATMENT DEVICE

(71) Applicant: Frank VAN LÜCK, Kaarst (DE)

(72) Inventor: Frank van Lück, Kaarst (DE)

(21) Appl. No.: 15/028,979

(22) PCT Filed: Oct. 7, 2014
(86) PCT No.: PCT/EP2014/071478

§ 371 Date: Apr. 13, 2016

(30) Foreign Application Priority Data
Oct. 15, 2013 (DE) 10 2013 017 181.4

(51) Int. Cl. B29C 44/26; B29C 44/36; B29C 51/00; B29C 44/34; B29C 44/56

(52) U.S. Cl. CPC B29C 44/26; B29C 44/3403; B29C 44/5636; B29C 51/002; B29C 44/36; B29K 2715/003

(57) ABSTRACT

For forming an extrusion-foamed plastic layer, the plastic layer is first thermally treated in order to be at least particularly plastically deformable. Negative pressure is exerted on the plastic layer, pulling it apart in the direction of the thickness as a plastic deformation. The plastic layer is optionally pressed together to a desired thickness or introduced into a mold. The negative pressure leads to a greater cell size homogeneity. The thickness of the plastic layer smoothed. Further, a corresponding aftertreatment device is proposed. This includes a thermal treatment device or thermal treatment zone. At least one pair of opposing negative pressure surfaces follows in conveying direction. These pull apart the plastic layer. Optionally, the plastic layer is additionally cooled. Further, and the plastic layer may be further processed in a subsequent fabricating unit.

### CROSS REFERENCE TO RELATED APPLICATIONS

This application is the U.S. National Phase Application of PCT/EP2014/071478, filed Oct. 7, 2014, which claims priority to German Patent Application No. 10 2013 017 181.4, filed Oct. 15, 2013, the contents of such applications being incorporated by reference herein.

### TECHNICAL FIELD

The method described here and the device described here concern the field of plastics processing of foams, in particular the aftertreatment in the form of afterfoaming and thermoforming of plastic foam bodies in the form of layers or sheets.

### PRIOR ART

It is known to produce foamed plastic layers by mixing polymer melt with foaming agent, which expands when the melt mixed with the foaming agent leaves through a die. Numerous applications equally require mechanically stable and thermally insulating properties, the size variation of the cells being directly linked to these properties. Furthermore, it is advantageous in the case of numerous applications, and in particular for automated processing, to have plastic layers with a thickness that remains as equal as possible.

It is also known to heat foamed plastic layers after storing them for a time during which the diffusion processes in the cells take place, to achieve a cell distribution that is as homogeneous as possible. This heating makes cell wall displacements possible, allowing different cell sizes to be partially equalized. What is more, during this heating process the plastic layer expands. This process is also referred to as afterfoaming.

The heating is usually followed by a rolling arrangement (afterfoaming) or a deforming station, which presses or forms the expanded plastic layer. However, in the case of such a process arrangement, after the heating the plastic layer is of a thickness that undesirably varies greatly (as a result of the production of the layer), this being manifested in particular by a waviness that makes further processing more difficult and reduces the quality of the product.

### SUMMARY OF THE INVENTION

An aspect of the invention is a procedure by which plastic layers can be produced with a constant thickness before the further pressing operation.

It has been recognized that, although the storing and heating makes cell equalizing processes (for example cell wall displacements) and expansion processes possible, the subsequent forming step, which merely exerts a pressing pressure on the cells, together with the heating cannot completely even out remaining inhomogeneities of the cell sizes. The procedure described here therefore envisages exerting a tensile force on the two opposite surfaces (in the direction of the thickness of the plastic layer) of the plastic layer, in particular before the plastic layer is pressed, for instance by rolling. It is envisaged that the surfaces of the plastic layer (or at least one of the surfaces) are exposed to a vacuum. As a result, cells that have previously become too small are increased in size, so that the subsequent pressing step starts from cell sizes that are homogenized to a greater extent than they are without exerting the tensile force. In particular, as a result the thickness can be increased without it varying over the length of the plastic layer. It has been recognized that, in particular after storing, the foaming agent in the cells does not build up a sufficiently strong and uniform internal pressure in the cells to ensure a homogeneous cell size distribution during the heating process. This is the case in particular with prolonged storage or volatile foaming agents, since during the storage foaming agent diffuses out of the cells and air diffuses in. It has been recognized in particular that, on account of the diffusion processes, the cell content does not produce a sufficient internal gas pressure during the heating to make a sufficient uniform plastic deformation possible in the sense of a cell wall displacement.

In order to compensate in particular for an overly weak expansion or cell wall displacement, the invention envisages applying a negative pressure to the plastic layer. This negative pressure is applied while the plastic layer is in a plastically deformable state (at least in certain portions) as a result of heating or generally thermal treatment. As a result of the negative pressure (and the internal pressure in the cell during the heating), the plastic layer expands, in particular substantially only in the direction of the thickness of the layer. A uniform thickness is achieved by applying the negative pressure or after applying the negative pressure. The thickness of the plastic layer is determined in particular by the distance of the vacuum device.

Therefore, a method for forming a foamed plastic layer, in particular an extrusion-foamed plastic layer, is described. As a result of the method, this plastic layer achieves a particularly low waviness and is provided in particular with a uniform thickness, i.e. with a thickness that deviates only very little from a prescribed thickness.

The method comprises a step (a) of thermally treating the plastic layer to a temperature that makes an at least partial plastic deformation of the plastic layer possible in the direction of the thickness of the plastic layer. In particular, the temperature is such that an internal pressure that is sufficient for the plastic deformation is produced in the cells by the gaseous cell content. This temperature depends on the melting temperature, as well as on the foaming agent located in the cells and in the cell walls of the plastics material and on the melting temperature range of the plastics material that forms the plastic layer, and lies in particular slightly (for example 30° C., 20° C. or even only 2° C.) below the melting temperature or the melting temperature range. This temperature is also chosen with allowance for the additional pressure that the gaseous cell content of the plastic layer produces as a result of the thermal treatment. During step (a), therefore, not only is the plastics material of the plastic layer brought into a plastically deformable state, but also the gaseous or liquid cell content of the cells of the plastic layer (which comprises diffused-in air or some other diffused-in foaming agent and/or at least one foaming agent introduced during the foam extrusion) is brought into a state in which this foaming agent, preferably the foaming agent addition, produces an increased internal pressure in the cells. As a result of the thermal treatment, the plastic layer is in a state in which the thickness of the plastic layer can at least partially increase plastically (and not only elastically).

In numerous forms of application that the procedure described here may take, an expansion in the plastic layer already occurs in the thermal treatment step. The thermal treatment gives the usually gaseous cell content a higher gas pressure, or the addition of the partial pressures of a number of foaming agents gives a higher overall gas pressure, whereby the cells increase in size plastically, whereby in particular the thickness of the plastic layer is increased. An increase in the thickness also takes place in step (b) (as described here, in particular a plastic deformation of the plastic layer as a result of applying negative pressure), these increases in the thickness in steps (a) and (b) being combined. The increasing of the thickness comprises a plastic deformation of the plastic layer in the sense of a not only elastic (i.e. with a restoring effect) but also at least partially plastic increase in the thickness. Since the pressure that causes the plastic deformation in step (a) is substantially only attributable to the vapor pressure of the gaseous cell content, for numerous applications the resultant deformation may not be quite complete, since the strength of the cell walls opposes maximum expansion. In step (b) described here, the increase in the thickness is therefore assisted by negative pressure.

The method also comprises the already mentioned step (b), in which negative pressure is exerted on the plastic layer. In particular, step (b) follows step (a), in order that the negative pressure is exerted on the thermally treated plastic layer in order to assist the increase in the thickness. Exerting the negative pressure assists and intensifies the plastic expansion of the cells in the plastic layer. The (relative) internal pressure that causes the expansion or the cell wall displacements is consequently not only produced by the thermal treatment (i.e. heating) of the plastic cell that leads to the increase in the vapor pressure of the gaseous cell content but also by the negative pressure that is applied to the plastic layer from the outside. This allows for instance the outward diffusion of a foaming agent with a higher vapor pressure than air and the inward diffusion of air to be equalized, in that the negative pressure has the effect that the (relative) internal pressure or the internal pressure in relation to the external pressure, and consequently the force of expansion of the cell, is increased. Similarly, this allows a differing cell size, which results from the resistance of the cell wall to a deformation, to be reduced, since the influence of the cell walls is reduced by the assisting function of the negative pressure.

During step (b) of exerting negative pressure, the plastic layer is preferably thermally treated, in particular thermally treated according to step (a) or to a temperature at which the plastic layer is at least partially deformable by the internal pressure. During step (b) of exerting negative pressure, the thickness of the thermally treated plastic layer increases.

Step (a) and in particular step (b) produce a plastic layer that is expanded greatly in thickness. In order according to a preferred embodiment to obtain a desired strength and to obtain a desired thickness and/or form, in an optional step (c) the plastic layer is deformed and in particular pressed together. This deforming or pressing together follows in particular step (b) and follows in particular step (a). The method therefore comprises a step (c) of deforming or pressing together the plastic layer to a predetermined thickness or form after the negative pressure is exerted. This thickness is in particular constant for a plastic layer or a group of plastic layers, but may also be changed to produce plastic layers with different thicknesses in each case. The thickness to which the plastic layer is pressed together or deformed is preferably constant from the beginning of the pressing together of a plastic layer to the end of the pressing together of this plastic layer. However, the thickness may also be changed during the pressing of the same plastic layer, in order to produce a desired thickness profile, or is determined by the deforming in a mold.

The thickness to which the plastic layer is pressed together defines a constant thickness profile or for specific applications may define a variable thickness profile. The cross section that is obtained by the deforming is preferably prescribed. The area content of the cross section after the deforming may be smaller than the area content of the cross section (preferably directly) before the deforming. The pressing together step is preferably carried out while the plastic layer is in a state in which it is at least partially plastically deformable, in particular at least partially deformable by the pressure with which the plastic layer is pressed together. Since this pressure may be higher than the pressure that acts on the plastic layer during step (a) and/or (b), the temperature of the plastic layer in step (c) may be lower. In specific cases, in step (c) the plastic layer may not have been thermally treated (for instance room temperature or other temperatures below the melting point or melting range of the plastics material of the plastic layer), the plastic layer being plastically deformed by the level of the pressure that acts on the plastic layer as a result of the pressing together. In step (c), the thickness of the plastic layer is reduced. Since there has already been great expansion in steps (a) and (b), a constant thickness of the plastic layer is achieved by step (c), in particular since a greater homogeneity of the cell sizes is achieved. It is also possible directly after step (c) to produce a plastic layer with low density, in particular lower than a density that would be obtained without step (b).

The method preferably provides that the plastic layer is conveyed, in particular in such a way that no significant tensile forces occur in the longitudinal direction of the plastic layer, such that the plastic layer would be significantly stretched (in particular plastically stretched). Significant stretching apart would be for example a stretching of more than +2%, +5%, +10%, +30% or +50% in the longitudinal direction of the plastic layer. The plastic layer is conveyed in its longitudinal direction.

It may also be provided that, before the thermal treatment of the plastic layer, it is retrieved from a stored state, for example by unwinding (from a storage reel) or by unfolding or else by simply feeding a plastic layer to be formed to step (a). This may involve initially producing the plastic layer to be formed and then storing it (for instance to make desired diffusion processes possible). The plastic layer to be formed may then be retrieved from the store and fed to the plastic forming process described here, in particular the method described here, preferably beginning with step (a). The storage preceding the thermoforming method may also serve for the afterexpansion.

Embodiments of the method provide that the pressing together of the plastic layer has the effect of reducing its thickness by plastic deformation. This reduction is for example at least 5, 10, 20 or 30% and in particular less than 70, 50, 40 or 35%, these merely being numerical values of very definite processes, and the procedure set out here can be adapted to the desired properties of the product. The plastic layer is pressed together by opposing pressing bodies, for example by a roller, a pair of rollers, or is deformed by opposing conveyor belts or in a forming station to form a multidimensional foam body, which at least in the direction of the thickness has a greater thickness than the afterexpanded plastic layer.

Further embodiments of the method provide that the plastic layer is thermally treated by means of a thermally controlled fluid flow. For thermally treating the plastic layer, this fluid flow comes into contact with it. Alternatively or in addition, the plastic layer may be thermally treated by directing thermal radiation or microwave radiation onto the plastic layer or by contact with thermally controlled bodies, such as for example a roller or a pair of rollers. Moreover, the plastic layer may be thermally treated during the production or at the end of the storage of the plastic layer, the latter being fed to step (b) in an at least partially plastically deformable state after being produced or after being stored.

Moreover, the plastic layer may be thermally treated and/or provided with a temperature that is linked with an at least partially plastically deformable state of the plastic layer while the negative pressure is being exerted and/or the plastic layer is being pressed together. The thermal treatment or the temperature of the plastic layer that ensures a plastic deformation of the plastic layer has the effect that the exertion of the negative pressure is automatically linked with a plastic deformation of the plastic layer. In combination with this, or alternatively, the plastic layer may solidify by cooling down during or after the pressing together or forming. The plastic layer may in particular solidify (preferably completely) once the plastic layer has been conveyed into a mold. This allows the plastically deformable state to be used not only for the plastic deformation during the exertion of the negative pressure but also in a (subsequent) process of forming by means of a mold. Between the forming by means of a mold and the preceding exertion of negative pressure, the plastic layer preferably does not solidify, at least not completely. Furthermore, the plastic layer may be thermally treated (once again) before the forming by means of a mold, to a temperature that allows an at least partial plastic deformation (substantially without disturbing the cell structure or opening cells) by the mold. An (additional) thermal treatment before the forming by means of the mold, in addition to the thermal treatment during or before the exertion of negative pressure, makes it possible that the plastic deformability for the forming by means of the mold and the plastic deformability during the exertion of the negative pressure can be set independently of one another.

Moreover, during the exertion of the negative pressure and/or during the pressing together, opposite surfaces of the plastic layer may be provided with a temperature at which these surfaces are substantially solidified. As a result, for example, an adhesive attachment can be prevented, while a plastic deformation in the region of the plastic layer between the surfaces is possible. This simplifies the step of exerting negative pressure.

The negative pressure may be exerted by opposing gas-permeable or open negative pressure surfaces. These negative pressure surfaces are connected to a negative pressure device, so that the negative pressure can be exerted by way of the negative pressure surfaces. The negative pressure surfaces preferably respectively extend in a plane, the planes in which the negative pressure surfaces extend being in particular parallel to one another and, furthermore, the plastic layer being conveyed parallel to and between these planes and in a direction parallel to the plastic layer. The negative pressure surfaces may furthermore be at a distance from one another that increases or decreases in the conveying direction of the plastic layer, in order to make allowance for the deformation of the plastic layer during the exertion of the negative pressure. This changing of the distance between the negative pressure surfaces is preferably less than 50%, 40%, 30%, 20% and in particular less than 10% or 5% of its length in the conveying direction of the plastic layer, and can therefore be regarded as virtually parallel alignment of the negative pressure surfaces in relation to one another.

In particular during the exertion of the negative pressure, the plastic layer is conveyed by the negative pressure surfaces by moving the negative pressure surfaces or is conveyed to and from the negative pressure surfaces by at least one conveying device.

Consequently, the negative pressure surfaces may not only be fixed in the conveying direction, but also be movable, in particular in the form of a conveyor belt that is gas-permeable, for instance a conveyor belt with a multiplicity of pores, so that the negative pressure can be applied through the conveyor belt. The conveyor belt, or its side facing the plastic layer, forms a negative pressure surface. Preferably provided are two conveyor belts (synchronized in movement), between which the plastic layer runs through. These conveyor belts also have the function of conveying the plastic layer while negative pressure is being applied. The negative pressure is applied through the conveyor belts. The conveyor belts may have a nonstick coating, in particular on their outer side.

In one embodiment, the negative pressure surfaces are not moved (i.e. are in the conveying direction) and are provided in particular by plates. These plates are preferably rigid. The plates have openings, by way of which the negative pressure is applied or can be applied. The openings may be provided as a multiplicity of through-holes or be porous. The plate thereby forms a perforated plate. The sides of the plates facing the plastic layer respectively form or comprise the negative pressure surfaces. At least one further conveying device, which transports the plastic layer, is provided. This at least one conveying device may be provided as a pair of rollers. For example, the pair of rollers, which are provided in the figure with the reference numeral 40, or the conveyor belts (which also serve as pressing surfaces), which are provided in the figure with the reference numeral 30, may provide the at least one conveying device (6). Moreover, a further pair of rollers may be provided upstream of the negative pressure surfaces in the conveying direction. The further pair of rollers preferably does not exert any pressure on the plastic layer that deforms it, but preferably merely a pressure that prevents any slipping between the pair of rollers and the plastic layer. The at least one conveying device is preferably operated in such a way (for instance by setting the torque or by setting the rotational speed) that the plastic layer does not undergo any significant plastic deformation in the conveying direction. This applies in particular to a conveying device that lies upstream of negative pressure surfaces in the conveying direction.

The conveying device may be designed as a pair of rollers, as a conveyor belt or as a conveyor chain. The conveying device may have anti-adhesive surfaces that are facing the plastic layer. The conveying device may also be thermally treated to a temperature that does not significantly change the phase state of the plastic layer at this location. Furthermore, the conveying device may have surfaces that are facing the plastic layer and contact it which have thermally insulating properties, for instance surfaces of plastic, in particular of a thin plastic layer, for example in the form of a conveyor belt.

It may also be provided that, after the vacuum treatment, the plastic layer is pressed together to the predetermined thickness. This is carried out by means of pressing surfaces arranged lying opposite one another, between which the plastic layer is guided. The arrangement of the pressing surfaces in relation to one another, and in particular the distance between them, defines the predetermined thickness. Furthermore, the elasticity of the plastic layer in the direction of the thickness may be taken into account, the predetermined thickness resulting from the distance between the pressing surfaces and the elasticity. The thickness is greater than the distance by an absolute amount, the absolute amount directly reflecting the elasticity. The pressing surfaces are in particular pressing surfaces of rollers or of conveyor belts or of plates. The pressing surfaces may be moved, preferably in the conveying direction, whereby the plastic layer is conveyed. The pressing surfaces may also be moved in relation to one another (i.e. the distance between the pressing surfaces may be variable and is in particular variable in a controlled manner). The thickness and also the distance are preferably constant and can be set according to the desired (in particular constant) thickness of the plastic layer. Furthermore, the distance may be controlled in such a way that a constant thickness or a desired thickness profile is obtained, in particular in order to equalize variations in elasticity. This corresponds to a closed-loop control in which the distance is changed as a manipulated variable in order to bring an error that results from variations in elasticity down to zero in a controlled manner, the error being determined by thickness measurements and comparison with a (constant or prescribed varying) desired thickness. The aim of the control is therefore an error of zero between the actual thickness and the desired thickness, the actual thickness being entered in the control as a measured variable. Instead of the distance, as described a pressing pressure may also be exerted and/or prescribed in order to achieve the thickness.

When rollers are used, the pressing surface is in the form of a strip, the term surface being used within the scope of this invention even in the case of a very small width of the pressing surface, i.e. in the case where the rollers provide a linear pressing surface, in particular since the pressing surface acts on the surface of the plastic layer, even if it itself forms virtually a line. The pressing surface is provided in particular by pressing bodies, which can preferably be realized as opposing rollers or conveyor belts, or else as plates, which are moved toward the plastic layer in order to press it together, and which after the exertion of the pressure are moved apart again, in order to be able to advance the plastic layer and exert renewed pressure. During the exertion of pressure, the plates are at the described (constant or prescribed) distance from one another.

A further aspect is a further aftertreatment device, which may also be referred to as a thermoformer. An aftertreatment device for extrusion-foamed plastic layers that is set up for performing the method described here is disclosed.

The aftertreatment device comprises a receptacle set up for continuously conveyed reception (i.e. preferably active feeding in the sense of a conveying device within the receptacle) of an extrusion-foamed plastic layer. This plastic layer preferably corresponds to the plastic layer previously described.

The aftertreatment device has a conveying direction, this preferably corresponding at least to a conveying direction of a conveying device of the aftertreatment device. Arranged downstream of the receptacle are opposing negative pressure surfaces, so that, when seen in the conveying direction, the negative pressure surfaces lie downstream of the receptacle. The negative pressure surfaces are connected to a negative pressure device of the aftertreatment device, it being possible for the negative pressure that is present at each surface to be controlled (or activated) between ambient pressure and 100 mbar. Arranged downstream (when seen in the conveying direction) of the negative pressure surfaces are pressing bodies arranged lying opposite one another. The pressing bodies have pressing surfaces, which are formed in particular in the way described above. The pressing surfaces of the pressing bodies lie opposite one another. The pressing bodies may be rollers, conveyor belts or plates that lie opposite one another in the way previously described.

The pressing bodies are mounted with respect to one another by way of a holding fixture or by way of a drive, it preferably being possible for the distance between the pressing bodies to be set. The negative pressure surfaces are preferably formed in the way described above and are preferably formed as conveyor belts that are air-permeable, for instance in that they have pores. The negative pressure device may be a vacuum pump, the negative pressure surfaces being connected to the negative pressure device over a certain area, for instance by way of a line which opens out onto the negative pressure surfaces and may have a flared end, in order to distribute the negative pressure over the negative pressure surfaces. In particular, extending from the negative pressure device, the line may open out into frames that are respectively adjoined by the negative pressure surfaces, so that the frame distributes the negative pressure over a certain area. A system of lines may be provided, in which a line respectively opens out on the negative pressure surfaces, and these lines are brought together to be connected to the negative pressure device.

The pressing surfaces have the effect of giving the plastic layer a thickness that is defined by the distance between these pressing surfaces. The pressing surfaces may also be regarded as thickness limiting surfaces and are formed in particular by at least one pair of opposing rollers.

Arranged upstream of the negative pressure surfaces is a thermal treatment device, by means of which steps (a) and (b) are carried out. The negative pressure surfaces and the thermal treatment device are formed in the way described here and are preferably set up to carry out steps (a) and (b) described here. The thermal treatment device is set up to bring the plastic layer to a temperature at which it is at least partially plastically deformable, in particular in order to make a plastic deformation (decompression) of the plastic layer possible at the negative pressure surfaces. The thermal treatment device acts in particular on a region that adjoins the receptacle and is followed by the negative pressure surfaces. The thermal treatment device may also extend over the negative pressure surfaces or act on them. For this reason, the thermal treatment device should not be regarded as a single component that is provided at precisely one point ahead of the negative pressure surfaces but should be conceived as a device that acts (possibly inter alia) on the region ahead of the negative pressure surfaces. In particular, the receptacle, the negative pressure surfaces, the pressing surfaces and/or the discharge gap may be provided within a zone on which the thermal treatment device acts. Preferably used for the heating is an oven, which forms the thermal treatment device and thus may be regarded (inter alia) as a thermal treatment device which is arranged upstream of the negative pressure surfaces since it acts on the zone ahead of the negative pressure surfaces. Therefore, the aftertreatment device comprises a thermal treatment device that acts at least on a zone lying ahead of the negative pressure surfaces (or is provided there). The directional and positional designations used here, such as upstream, downstream, etc., concern the conveying direction of the at least one conveying device of the aftertreatment device. The conveying devices of the aftertreatment device have substantially the same conveying speed, in order not to subject the plastic layer to a longitudinal force, and in particular in order not to stretch the plastic layer significantly in length. This may be realized by means of an open-loop control device of the drives of the conveying devices, which is designed for controlling the conveying speeds of the conveying devices.

One embodiment of the aftertreatment device provides that the negative pressure device has a conveying device that is provided with contact elements. This conveying device may be formed as a conveyor belt device with two (or more) opposing conveyor belts, the conveyor belts running around rotary rollers that drive the conveyor belts. The contact elements are formed by the outer sides of the conveyor belts or are fastened to them. The contact elements are movably drivable in a discharging direction of the discharge slit. The discharging direction corresponds to the conveying direction described here. The contact elements may comprise at least portions of the negative pressure surfaces. In particular, the conveyor belts or longitudinal portions of the conveyor belts may form the negative pressure surfaces. Furthermore, the negative pressure surfaces may be provided on the contact elements.

Opposing conveyor belts are used, preferably at least one first conveyor belt and a conveyor belt lying opposite it, these belts being respectively mounted by rotary rollers, so that at least two conveying devices that respectively have a conveyor belt and mounting rotary rollers lie opposite one another. Such opposing conveyor belts may be used in order to provide a conveying device in the receptacle, upstream of the discharge slit, at the negative pressure surfaces, and/or at the pressing surfaces. In particular, opposing conveyor belts may form the receptacle, the discharge slit, the negative pressure surfaces, and/or the pressing surfaces. It may be the case here that individual conveyor belts that are arranged one after the other are provided in the receptacle, upstream of the discharge slit, at the negative pressure surfaces, and/or at the pressing surfaces, or it may be the case that conveyor belts that extend over at least two of the aforementioned components (receptacle, discharge slit, negative pressure surfaces and pressing surfaces) are provided. It may also be the case that only a subgroup of these components have opposing conveyor belts or generally have a conveying device. At the negative pressure surfaces, the conveyor belts are open-pored or in some other way gas-permeable, so that the negative pressure can act on the plastic layer. The distance between the opposing conveyor belts at the pressing surfaces or at the discharge slit at which the plastic layer is discharged again is in particular less than the distance between the opposing conveyor belts on negative pressure surfaces. Two conveyor belts may be provided, lying opposite one another and extending at least over the negative pressure surfaces, or realizing them. Instead of or in combination with the conveyor belts, rollers may be used, in particular in order to form at least one conveying device of the aftertreatment device. Opposing rollers may be used, in order to form the pressing surfaces and equally to form a conveying device. For the distance between the rollers, the same applies as for the conveyor belts. Furthermore, the outer surfaces of the rollers may also have a nonstick coating. Moreover, the rollers and the conveyor belts or the drive rollers of the conveyor belts may be designed in a thermally controllable manner, in particular in that they have thermal fluid channels that can be connected to a thermal treatment device. The rollers or conveyor belts may also be provided in a thermal treatment device or thermal treatment zones, in particular in an oven or under heat emitters. Furthermore, a microwave source, an IR emitter or an electrical heater may be provided within the aftertreatment device, in order to thermally treat the plastic layer and in order to provide the thermal treatment device, it also being possible for heated heat transfer fluid to be used for the thermal treatment and for the thermal treatment device to be formed as a source for such a heat transfer fluid.

The discharge slit or the pressing surfaces may be adjoined by a mold, in particular a mold such as that described above. The mold is in particular a thermally controlled mold and is preferably formed as a pair of opposing rollers or plates containing a mold cavity and having in particular a thermal treatment device, for example cooling channels or generally channels for a thermal medium. The mold may be formed as a fabricating unit and in particular comprise cutting elements in order to cut the (solidifed) plastic layer to prescribed dimensions. The mold may have a negative pressure connection or be connected to a negative pressure generator, in particular to the negative pressure source, which is also connected to the negative pressure surfaces.

### BRIEF DESCRIPTION OF THE DRAWINGS

FIG. 1 shows an embodiment of the aftertreatment device described here in a schematic way for explaining the method described here.

### DETAILED DESCRIPTION OF THE INVENTION

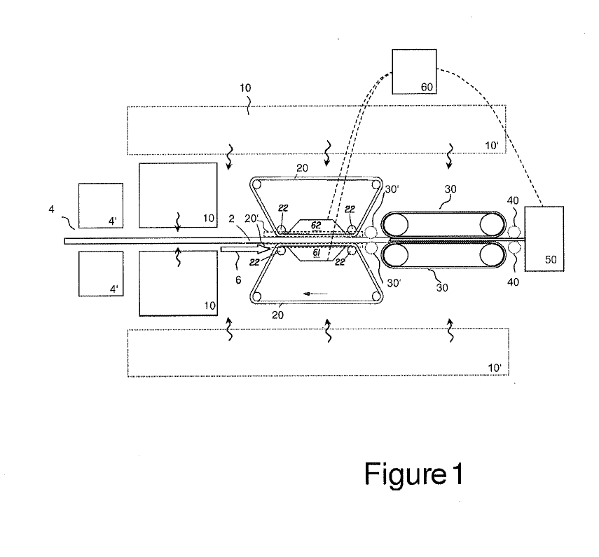

The embodiment of an aftertreatment device that is represented in FIG. 1 is designed for the forming of an extrusion-foamed plastic layer 2. This is introduced into the aftertreatment device by way of a receptacle 4, a gap in a guide that is formed by two opposing guiding elements 4′ (for instance fixed plates or rollers) being represented in particular by the reference numeral 4. The guiding elements 4′ may also be driven, opposing conveyor belts or chains. Arranged downstream of the feed 4 in the conveying direction 6 of the aftertreatment device is a thermal treatment device 10, or a zone on which the thermal treatment device 10 or a thermal treatment device 10′ extending over further components 20, 30 acts.

Following in the conveying direction 6 are opposing conveyor belts 20, which are respectively mounted on rollers 22, or plates 20′. These conveyor belts or plates form opposing negative pressure surfaces, as described more specifically further below. The plates are represented by dashed lines as a further alternative. The plates are provided in pairs and in particular are arranged lying opposite one another.

The conveyor belts 20 or plates 20′ are followed in the conveying direction 6 by opposing pressing surfaces, which are formed as opposing conveyor belts 30, and/or by rollers 30′, or are followed by a mold 50. Like the thermal treatment device 10′, the rollers 30′ are optional. Similarly, upstream of the mold 50, the rollers 30′, the conveyor belts 30 and the rollers 40′ may be combined as desired, i.e. arranged in any desired sequence as seen in the conveying direction.

The negative pressure surfaces within the conveyor belts 20 or plates 20′ have the effect that the plastic layer 2 is pulled apart in the direction of its thickness, in order that even cells of a small form can be given more volume. There then follow the pressing surfaces of the conveyor belt 30 or the rollers 30′ or of the mold 50, which reduce to a desired thickness the thickness of the plastic layer 2 that has been increased by the negative pressure surfaces of the conveyor belt 20. This desired thickness is smaller than the thickness that the plastic layer 2 has at the receptacle 4 if no mold 50 is used. This results in a uniform size distribution of the cells in the plastic layer. It should be noted that the thermal treatment devices 10 and 10′ make possible a plastic deformation at the negative pressure surfaces of the conveyor belts 20 and at the pressing surfaces of the conveyor belts 30 or at the rollers 30′ by these devices thermally treating the plastic layer 2 to a temperature at which the plastic layer 2 is not completely solidified, and in particular undergoes plastic (i.e. permanent) deformations by pressure or tension in the direction of the thickness. The components designated by the reference numerals 20, 22, 30, 30′ and also 61 and 62 have in comparison with the plastic layer 2 a temperature that prevents complete solidification. In other words, neither the components 20, 30 nor 30′ cool the entire plastic layer 2 to a temperature below the solidification temperature or below the solidification temperature range.

With the optional conveyor belt 30 or with the rollers 30′, the process of the method according to the invention of homogenizing the cell sizes is brought to an end. However, further treatment processes may follow, for instance cooling and/or further pressing or forming. For this purpose there may be provided a pair of cooled rollers 40 and also a downstream mold 50, which fabricates or cuts to size the cooled plastic layer. Alternatively, the pressing surfaces may be followed by a mold 50, which processes the plastic layer in such a way that it is not completely solidified and brings it into a final form, a pair of cooled rollers 40 not being provided in this case. Apart from that, the mold may be connected to a negative pressure source 60, with which the plastic layer is held or formed within the mold.

The negative pressure source 60 is also connected by way of lines for distributing the negative pressure (represented by dashed lines) to frames 61 and 62 that are open with respect to the plastic layer and the openings of which are provided from the inside against the conveyor belts 20 or plates 20′. The negative pressure of the negative pressure source is applied from the lines (represented by dashed lines) by way of the frames 61 and 62 that are open toward the plastic layer 2, and may also be regarded as extensions of the lines, to an (inner) side of the conveyor belts 20 or plates 20′. The gas permeability of the conveyor belts 20 or plates 20′ has the effect that the negative pressure is transferred to the opposite (outer) side of the conveyor belts 20 or plates 20′, which is facing the plastic layer or is facing a central gap in the aftertreatment device which is set up for receiving the plastic layer.

A comparable embodiment provides two opposing conveyor belts, in which both the open frames 61 and 62 and the rollers of the conveyor belts 30 are accommodated. In other words, these conveyor belts form both the negative pressure surface and the pressing surface. The frames 62, 61 or their openings are at a greater distance from one another than the rollers at which the conveyor belts form the pressing surfaces. Consequently, the distance between the conveyor belts diminishes in the conveying direction 6 to a distance that leads to the desired thickness of the plastic layers. The distance between the negative pressure surfaces is greater than the thickness of the plastic layer 2 that is fed to the receptacle 4. The gap between the conveyor belts consequently narrows in the conveying direction 6.

The open frames 61, 62 are respectively open on one side and form an opening that is facing the plastic layer 2. This opening of the frames 61, 62 may also be regarded as a negative pressure surface, especially since the (optional) conveyor belts only pass on the negative pressure that is present at the frames 61, 62 to the plastic layer 2 and a direct application of the negative pressure through the frames 61, 62 to the plastic layer is conceivable in principle. The open frames 61, 62 form in particular the negative pressure device, while the respective opening of the open frames forms the respective negative pressure surface. As a result of the direct arrangement of the opening on the frames, the negative pressure device is connected to the negative pressure surface.

Numerous embodiments of the invention have the following properties. A method suitable for forming the extrusion-foamed plastic layer 2 provides that the plastic layer is first thermally treated in order to be at least partially plastically deformable. Then, negative pressure is exerted on the plastic layer and, as a result, it is pulled apart in the direction of the thickness in the sense of a plastic deformation. After the exertion of negative pressure, the plastic layer is pressed together to a desired thickness. The preceding exertion of negative pressure has the effect of achieving a greater homogeneity of the cell sizes, and therefore the plastic layer is provided with a constant thickness after the pressing together.

Furthermore, an aftertreatment device for carrying out the method is provided. This comprises firstly a thermal treatment device 10 or thermal treatment zone for the thermal treatment. There follows in the conveying direction 6 at least one pair of opposing negative pressure surfaces, with which the plastic layer is pulled apart in the direction of the thickness. There then follows a pair of opposing pressing surfaces for the pressing together of the plastic layer. Optionally, after that the plastic layer 2 is cooled, for instance by a stream of fluid or by cooled rollers 40, preferably arranged in pairs. After that, the plastic layer may be further processed in a fabricating unit 50.

### LIST OF REFERENCE NUMERALS

2 plastic layer
4 receptacle
4′ guiding elements
6 conveying direction
10, 10′thermal treatment device
20 conveyor belts, in particular for representing the negative pressure surfaces
20′ plates containing negative pressure surfaces
22 rollers for mounting the conveyor belts 20
30 conveyor belts, in particular for representing the pressing surfaces
30′ optional rollers for representing the pressing surfaces
40 cooled rollers (arranged in pairs)
50 mold or fabricating unit
60 negative pressure source
61, 62 frames that are open on one side and are arranged on both sides of the plastic layer 2

Connecting lines represented by dashed lines are fluid lines for transferring the negative pressure of the negative pressure source. If plates 20′ are used, they are similarly connected to the fluid lines, the further representation of fluid lines that lead to the plates 20′ are omitted for the sake of better understanding of the figure.

Components represented by dotted lines are optional, it also being possible for other components to be optional, for instance component 50 or else the plates 20′ that are represented by dashed lines. If plates 20′ are used, the conveyor belts 20 are optional and in particular are dispensable.

1. A method for forming an extrusion-foamed plastic layer with a uniform thickness, wherein the method comprises: (a) thermally treating the plastic layer to a temperature that makes an at least partial plastic deformation of the plastic layer possible in a thickness direction of the plastic layer; and (b) exerting a negative pressure on the thermally treated plastic layer, such that the thickness of the thermally treated plastic layer increases.

2. The method as claimed in claim 1, wherein the method also comprises: (c) pressing together the plastic layer to a predetermined thickness or deforming the plastic layer after the negative pressure has been exerted on it, the pressing together or deforming of the plastic layer having the effect that the thickness of the plastic layer is reduced by plastic deformation or is given a prescribed form before a final shaping of the product takes place.

3. The method as claimed claim 1, wherein the thermally treating comprises: thermally treating the plastic layer thermally controlled fluid flow, which for thermally treating the plastic layer comes into contact with it, or thermally treating the plastic layer by directing thermal radiation or microwave radiation onto the plastic layer, or thermally treating the plastic layer during the production of the plastic layer, or by direct heat transfer by contact, further comprising: feeding the latter plastic layer to step (b) in an at least a partially plastically deformable state after being produced.

4. The method as claimed in claim 1, further comprising: thermally treating the plastic layer and/or providing the plastic layer with a temperature linked with an at least partially plastically deformable state of the plastic layer while exerting the negative pressure is on the plastic layer and/or optionally pressing together the plastic layer; further comprising: solidifying the plastic layer by cooling down during or after pressing together the plastic layer, by solidifying the pressed-together plastic layer after having been conveyed into a mold or a rolling device.

5. The method as claimed in claim 2, wherein, during the exertion of the negative pressure and/or during the pressing together, opposite surfaces of the plastic layer are provided with a temperature at which these surfaces are substantially solidified, for preventing an adhesive attachment.

6. The method as claimed in claim 1, further comprising: exerting the negative pressure by opposing gas-permeable or open negative pressure surfaces connected to a negative pressure device, further comprising, during exerting the negative pressure, conveying the plastic layer by the negative pressure surfaces by moving the negative pressure surfaces, or wherein, during exerting the negative pressure, not moving the negative pressure surfaces, which are provided by plates.

7. The method as claimed in claim 1, wherein, after exerting the negative pressure, pressing together the plastic layer to the predetermined thickness by pressing together surfaces, which are arranged opposite one another, and guiding, the plastic layer between the surfaces, by pressing surfaces of rollers or conveyor belts together, wherein the plastic layer is conveyed by moving the pressing surfaces.

8. An aftertreatment device for extrusion-foamed plastic layers comprising:
a receptacle set up for continuously conveyed reception of an extrusion-foamed plastic layer, wherein the aftertreatment device has a conveying direction;
opposing negative pressure surfaces, connected to a negative pressure device, is arranged downstream of the receptacle along the conveying direction wherein
a thermal treatment device is arranged upstream of the negative pressure surfaces of the aftertreatment device or a zone on which the latter thermal treatment device acts is arranged upstream of the negative pressure surfaces, and
pressing bodies, lying opposite one another, are optionally arranged downstream of the negative pressure surfaces, before the rolling or thermoforming are carried out.

9. The aftertreatment device as claimed in claim 8, wherein the negative pressure device has a conveying device having contact elements, which are movably drivable in the conveying direction of the conveying device, wherein the contact elements comprise at least portions of the negative pressure surfaces or the negative pressure surfaces are provided on the contact elements.
